(19) United States
(12) Patent Application Publication
(10) Pub. No.: US 2026/0030537 A1
(43) Pub. Date: Jan. 29, 2026

(54) Method and System for Novelty Assessment Using the McGinty Equation including Hydrogen-Splitting Semiconductor Materials for Solar Energy Conversion and Storage

(71) Applicant: Christopher Richard McGinty, Chanhassen, MN (US)

(72) Inventor: Christopher Richard McGinty, Chanhassen, MN (US)

(21) Appl. No.: 18/532,050

(22) Filed: Dec. 7, 2023

(51) Int. Cl. G06N 10/60

(52) U.S. Cl. CPC G06N 10/60

(57) ABSTRACT

This patent application introduces a novel and comprehensive method for assessing novelty in quantum physics and related technical fields using the McGinty Equation (MEQ). The McGinty Equation, represented as Ψ(xt)=ΨQFT(xt)+ΨFractal(xtDmqs)+ΨGravity(xtG), uniquely integrates quantum field theory (QFT), fractal geometry, and gravitational theory into a unified mathematical framework. This integration enables the equation to capture the complex interactions and behaviors of particles and fields at quantum scales, offering a versatile tool for a broad spectrum of scientific and technological applications. Key applications of the MEQ include advancements in quantum computing, material science, environmental modeling, energy generation, and medical imaging. The invention's novelty lies in its unique approach to amalgamating disparate physical theories, providing significant insights into the quantum realm and facilitating technological innovations.

### CROSS-REFERENCE TO RELATED APPLICATIONS

This application claims priority to and is a continuation-in-part of U.S. Provisional Patent Application No. 63/451,826, filed on Mar. 13, 2023. The provisional application, which details the early conceptualization of the McGinty Equation for assessing novelty in quantum physics, is incorporated herein by reference for its supportive teachings and foundational concepts.

### FEDERALLY SPONSORED RESEARCH AND DEVELOPMENT

Not Applicable. This invention did not receive any federal government funding and therefore is not subject to any government rights in the patent.

### JOINT RESEARCH AGREEMENT

Not Applicable. This invention was solely developed by the inventor, Chris McGinty, without any collaborative joint research agreements.

### INCORPORATION-BY-REFERENCE

The contents of the .docx files: Referenced herein and incorporated by reference is the detailed text (.docx) files named
‘Non_Provisional_Utility_Patent_Application_McGinty_Equation_MEQ_Process_and_Future_Cla ims_with_Exhibit_A.docx’ and
‘McGinty_Equation_MEQ_Exhibit_B_Hydrogen_Splitting_Semiconductors_Utility_Patent.docx’, submitted via the USPTO patent electronic filing system on Dec. 7, 2023, are hereby incorporated by reference. Both files contain critical supplementary information, including mathematical derivations and experimental data, relevant to the invention of the McGinty Equation.

### STATEMENT REGARDING PRIOR DISCLOSURES

To the best of the inventor, Christopher R. McGinty's knowledge and belief, there have been no prior public disclosures or publications of the invention described herein, either by the inventor or any joint inventors, prior to the effective filing date of this application.

### BACKGROUND OF THE INVENTION

### Field of the Invention

The present invention operates within the field of quantum physics, offering a novel approach for assessing novelty and innovation through the McGinty Equation. This equation is particularly relevant for advancing the understanding of complex quantum phenomena and their practical applications in technology and science.

### Description of Related Art

Existing methods and systems in quantum physics have primarily focused on isolated aspects of quantum mechanics, lacking a comprehensive framework that unifies quantum mechanics with fractal geometry and gravitational theory. The McGinty Equation, by contrast, offers an innovative approach that bridges these gaps, representing a significant leap forward from the existing state of the art.

### SUMMARY OF THE INVENTION

The invention introduces a transformative method and system for calculating novelty in technical and scientific fields using the McGinty Equation, a unified mathematical expression. This equation amalgamates quantum field theory, fractal geometry, and gravitational theory into a cohesive framework, offering an unprecedented tool for analyzing and predicting quantum behaviors and interactions.

### BRIEF DESCRIPTION OF DRAWINGS

The invention is best understood through its mathematical expressions and theoretical descriptions. However, graphical representations of the equation's applications are provided. Exhibit B contains a graphical representation with a detailed description of the key elements of each of the McGinty Equation's twenty-eight algorithms employed in Hydrogen-Splitting Semiconductor Technology.

FIG. 1 conceptually illustrates a schematic representation of MEQ components.

FIG. 2 conceptually illustrates an advanced medical imaging system that is grounded in the principles of MEQ.

FIG. 3 conceptually illustrates a quantum-enhanced GPS system that utilizes the principles of MEQ to guide its operations.

FIG. 4 conceptually illustrates quantum gravitational climate engineering based on MEQ principles.

FIG. 5 conceptually illustrates astrophysical applications of MEQ.

FIG. 6 conceptually illustrates MEQ-based Zero Point Energy (ZPE) harvesting and storage.

### DETAILED DESCRIPTION OF THE INVENTION

This section provides a comprehensive description of the McGinty Equation (MEQ), its foundational theoretical concepts, mathematical formulation, and its diverse applications. The invention's novelty lies in its unique integration of quantum field theory, fractal geometry, and gravitational theory, offering a versatile tool for a broad spectrum of scientific and technological applications.

Theoretical Foundation: The McGinty Equation is based on the principles of quantum physics, incorporating advanced concepts from fractal geometry and gravitational theory. This innovative approach enables the equation to capture the complex interactions and behaviors of particles and fields at quantum scales.

Mathematical Formulation: The MEQ is mathematically represented as Ψ(xt)=ΨQFT(xt)+ΨFractal(xtDmqs)+ΨGravity(xtG), where:

ΨQFT(xt): Represents the quantum field theory component, capturing the standard behavior of quantum fields without external influences. This term forms the baseline from which the effects of fractal geometry and gravitational interactions are measured.

ΨFractal(xtDmqs): Embodies the fractal geometry component, introducing a novel perspective on the scale-dependent behaviors of quantum systems. The parameters within this term, including D (fractal dimension), m (mass), q (charge), and s (scale factor), allow for a detailed representation of fractal structures within quantum fields.

ΨGravity(xtG): Accounts for the effects of gravitational theory, particularly the perturbative influences of gravity on quantum fields. The term G represents the gravitational constant, integrating Einstein's theory of general relativity into the quantum realm.

Integration and Synergy of Components: The MEQ's distinct components work synergistically, providing a more comprehensive understanding of quantum phenomena. This integration allows for novel insights into the interplay between quantum mechanics, fractal structures, and gravitational forces, which were previously analyzed in isolation.

### Applications of the McGinty Equation:

The MEQ finds applications in a wide array of fields, including but not limited to:
Quantum Computing: Utilizing MEQ for the development of advanced quantum algorithms, enhancing computational capabilities in areas like cryptography and optimization.
Material Science: Applying MEQ to design materials with unique, scale-dependent properties, potentially revolutionizing fields such as nanotechnology and biomedicine.
Environmental Modeling: Leveraging MEQ for more accurate and adaptive models in climate research and ecological predictions, contributing significantly to environmental conservation efforts.
Medical Imaging: Employing MEQ in the development of advanced medical imaging techniques, facilitating more precise diagnostics and treatment planning.

### Modified Forms of MEQ:

In addition to the standard form, the invention encompasses modified versions of MEQ, tailored for specific applications or scenarios. These modifications involve adjusting the parameters within the fractal geometry and gravitational terms to suit particular requirements, thereby expanding the utility of the McGinty Equation in various domains.

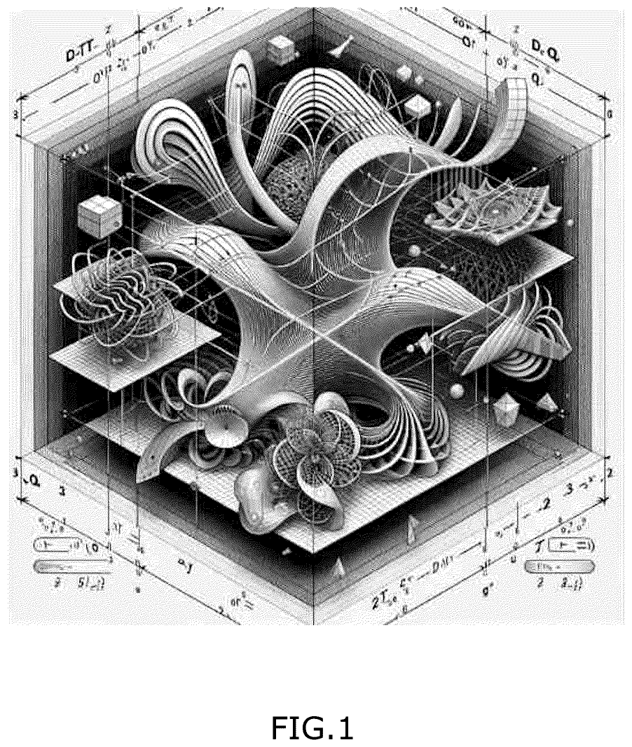

FIG. 1 is a schematic diagram that illustrates the core components of MEQ. The image is a creative and intricate representation of the components of the McGinty Equation (MEQ) set against a backdrop that resembles a coordinate system for scientific visualization. It's a stylized artistic interpretation, meant to visually convey complex scientific concepts.

The key components of the MEQ outlined in the image are:

ΨQFT(x,t): This denotes the quantum field theory component of the equation, which is a fundamental framework for describing the behavior of quantum fields. In the visual, this may be represented by the various geometric and wave-like patterns, suggesting the dynamic nature of quantum fields.

ΨFractal(x,t,D,m,q,s): Fractals are patterns that repeat at different scales and are typically very complex. This term of the MEQ likely deals with the fractal nature of certain physical phenomena. The image may use spirals, repeating patterns, or structures that appear similar at various scales to represent this fractal aspect.

ΨGravity(x,t,G): This represents the gravitational component, which accounts for the influence of gravity on the quantum fields described by the MEQ. Visually, this might be shown as warps or distortions in the patterns, indicating the bending of space and time due to gravity.

The illustration combines these elements into a single cohesive image that seems to float within a cubic space, denoting the “warp bubble” concept often discussed in relation to faster-than-light travel theories like the Alcubierre Drive. The patterns and shapes within the cube can be interpreted as a visual metaphor for the complex interplay of quantum mechanics, fractal mathematics, and gravitational physics. The various layers and interwoven structures suggest a level of interconnectedness and complexity that is characteristic of the universe at the quantum level. The illustration visually express how these different physical elements come together to form the MEQ, highlighting its potential applications in advanced scientific research and technology. The surrounding annotations and symbols reference the mathematical nature of the equation, grounding the artistic representation in the language of science. Overall, the image serves as a bridge between abstract scientific concepts and visual art, making the ideas it represents more accessible and engaging to a broader audience.

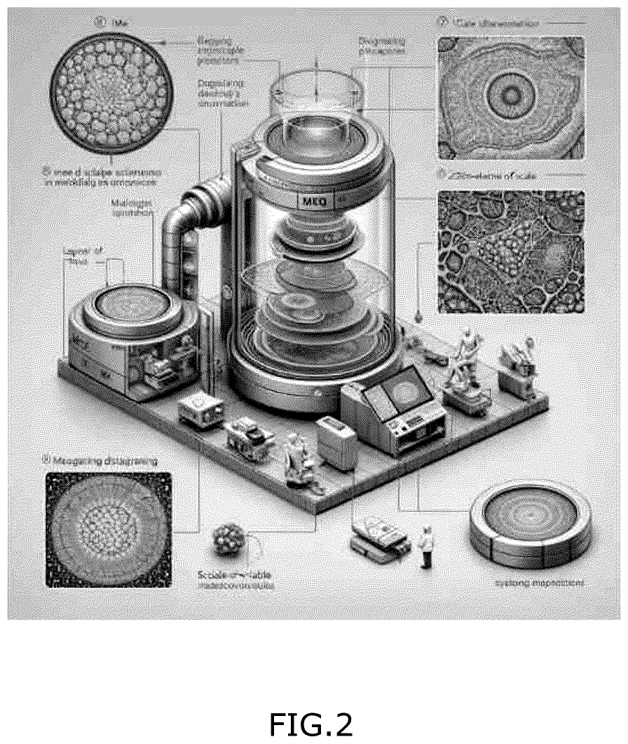

FIG. 2 depicts a highly stylized, conceptual representation of an advanced medical imaging system, grounded in the principles of the McGinty Equation (MEQ). Here is an expanded description based on the components visible in the image and the description you've provided:

MEQ-Based Imaging Device: The central structure in the image is an advanced medical imaging device, which employs MEQ principles to enhance its capabilities. The layers and concentric rings symbolize the device's ability to dynamically adjust and focus on different scales of observation, from the macroscopic anatomy of patients down to cellular or even molecular levels.

Dynamic Scale Adjustment: The MEQ's scale-variable properties allow for a seamless transition between various levels of detail. This suggests that the imaging device can adapt in real-time to the diagnostic needs, whether examining the overall structure of an organ or zooming in on the intricate details of tissue or cellular structures.

Medical Diagnostics and Imaging: The insets on the sides of the image represent medical images produced by the MEQ-based system. These images exhibit patterns at different scales, likely indicating the system's versatility in capturing high-resolution images at various levels of magnification.

Practical Implementation in Medical Fields: The surrounding environment, which includes figures operating machinery and computers, emphasizes the practical application of MEQ in a clinical or research setting. It suggests that the MEQ can be integrated into existing medical workflows, potentially enhancing the precision and efficacy of medical diagnostics.

Illustrative Medical Images: The detailed, fractal-like patterns in the medical images indicate the ability to identify and diagnose conditions that manifest in complex patterns within the body. This could be particularly useful in the diagnosis of diseases that affect the microstructure of tissues, such as certain types of cancer or fibrotic diseases.

Adaptability and Precision: The focus on adaptability and precision reflects the potential for MEQ-based technology to provide new insights into medical conditions, enabling healthcare professionals to diagnose and understand diseases with a level of detail previously unattainable.

While now mathematically possible this is currently conceptual. The image conveys how the integration of MEQ principles into medical imaging technology could revolutionize the field of medical diagnostics by providing a tool capable of detailed, scale-variable observation and analysis. This could lead to earlier and more accurate diagnoses, customized treatment plans, and a deeper understanding of complex medical conditions.

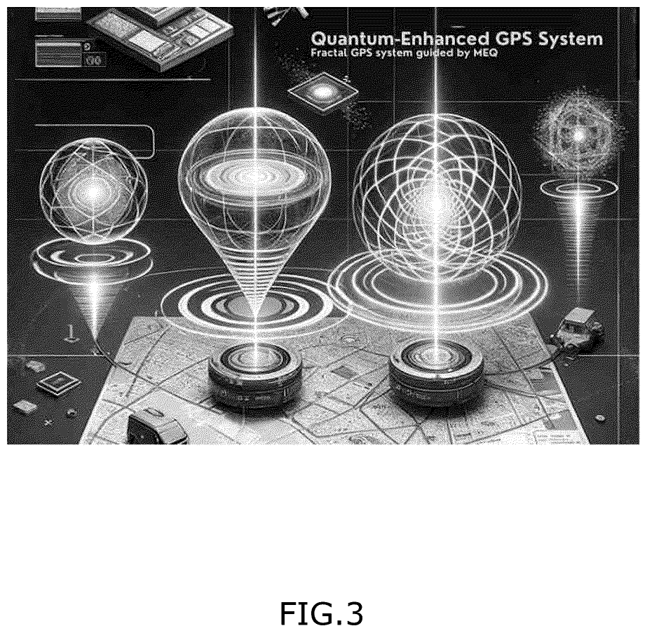

FIG. 3 is an illustration that depicts a conceptual Quantum-Enhanced GPS System that utilizes the principles of the McGinty Equation (MEQ) to guide its operations. The visual elements suggest a sophisticated integration of quantum technology with fractal mathematics to enhance the precision and functionality of GPS systems.

Quantum Technology Integration: At the core of the system is a quantum device or sensor, which takes advantage of quantum superposition and entanglement to achieve highly accurate positioning data. This quantum-enhanced accuracy could far surpass that of conventional GPS systems.

Fractal GPS System: The use of fractal principles suggests that the system can tap into fractal geometry's self-similarity and scale-invariance properties to improve signal processing or to manage the distribution of GPS satellites more efficiently.

MEQ-Guided System: Guided by the MEQ, the system is capable of performing complex computations that consider quantum field theory and gravitational effects, providing a new level of accuracy in geolocation that accounts for variables such as gravitational field variations on Earth.

Visualization of Signal Paths: The multiple layers of concentric circles and connecting lines indicate the paths of GPS signals from satellites to receivers on Earth, with a focus on the MEQ's influence on signal propagation and processing.

Potential Applications: Such a system could revolutionize navigation in various sectors, including autonomous vehicles, aerospace navigation, and even personal devices, providing unprecedented accuracy and reliability.

User Interface and Experience: The image suggests a user-friendly interface, with a clear display of location data. The futuristic design implies a system that is accessible and provides real-time updates to users.

While now mathematically possible this is currently conceptual. The concept as a whole presents a significant leap in GPS technology, suggesting a future where quantum computing's immense processing power and the complex mathematics of fractals can be harnessed to provide ultra-precise location data. While now mathematically possible this is currently conceptual. Such technologies could have far-reaching implications, from improving global communication networks to advancing space exploration.

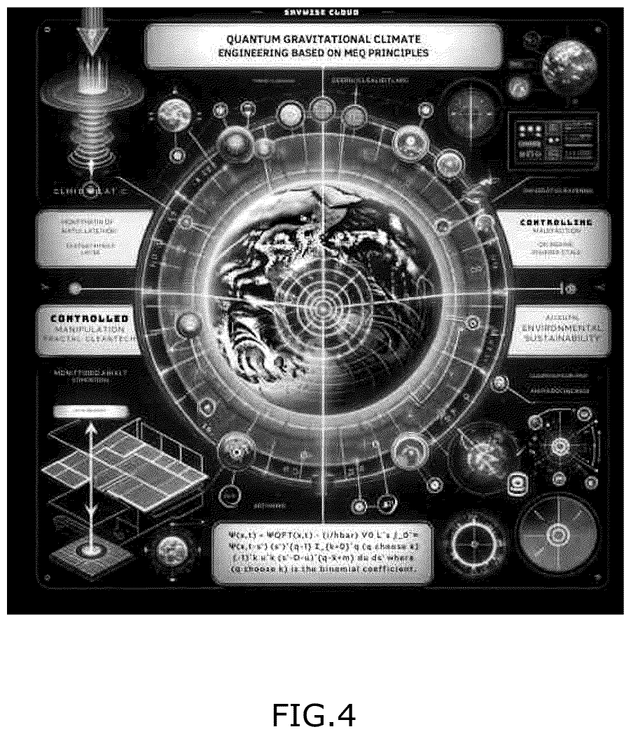

FIG. 4 is an image that portrays a futuristic concept for Quantum Gravitational Climate Engineering based on McGinty Equation (MEQ) principles. This visualization depicts a sophisticated system designed to influence or control the Earth's climate using advanced quantum and gravitational techniques. The key components of the image include:

Earth's Visualization: The planet is centrally featured, surrounded by a network of nodes and lines that represent satellite systems or other technological devices designed to monitor and manipulate climatic factors.

Quantum Technology: The beams and waves emanating from and converging on the Earth imply the use of quantum mechanics and gravitational fields to achieve highly accurate climate modeling and potential manipulation of weather patterns.

Controlled Manipulation and Fractal Cleantech: This aspect of the system refers to precise, intentional interventions in the Earth's atmospheric conditions to promote environmental sustainability. It suggests the application of fractal mathematics and clean technology solutions to enhance climate control measures.

Solar Panels and Renewable Energy: The image includes solar panels, indicating the integration of renewable energy sources, which is consistent with sustainable environmental engineering practices.

Equation Representation: An equation is displayed, a form of the MEQ, incorporating quantum field theory (QFT) and fractal geometry to address complex climate variables.

Environmental Sustainability: The mention of environmental sustainability implies that the goal of this system is not only to manipulate climate factors but to do so in a way that supports the long-term health and balance of the planet's ecosystems.

Interface and Data Analysis: The various screens and interfaces depicted in the image represent the user interaction points for monitoring and controlling the system. They suggest that operators could have real-time access to climate data and the ability to adjust parameters accordingly.

The image captures the vision about what might be possible with the integration of advanced physics, technology, and environmental science. It represents a vision for a future where global climate challenges are addressed through innovative, quantum-inspired solutions that are in harmony with the goal of sustaining the Earth's environment. While now mathematically possible this is currently conceptual.

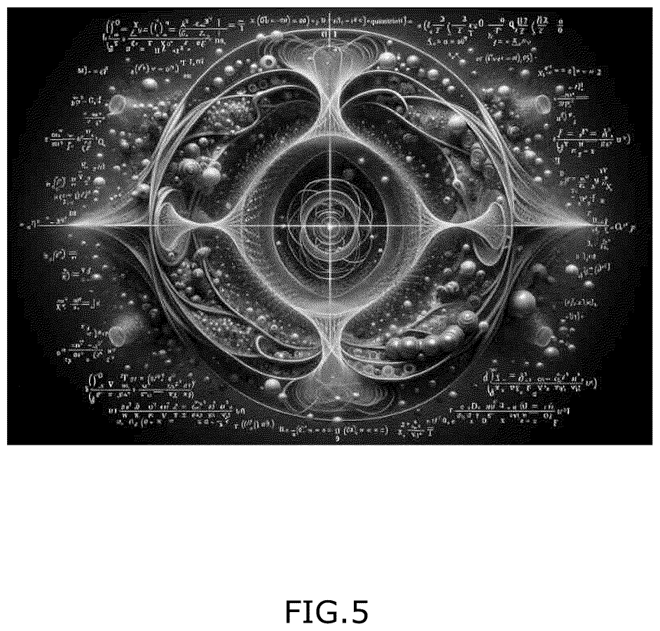

FIG. 5 is a visual aid that illustrates the application of MEQ in astrophysics and cosmology. The image is a visually striking representation that blends elements of science, particularly physics and mathematics, with artistic flair. It features an intricate array of geometric patterns, symbols, and equations, suggesting a deep connection between various scientific principles and the underlying structure of reality.

Central Vortex and Symmetry: The central feature of the image is a vortex-like structure that creates a sense of depth and dimensionality. This symbolizes a black hole, wormhole, or other phenomena that warps spacetime, resonating with the principles of general relativity and quantum mechanics.

Equations and Symbols: Surrounding the central image are numerous equations and mathematical symbols. These represent various physical laws and quantum equations, including elements of the MEQ, which encompasses quantum field theory and fractal geometry.

Fractal Elements: The use of fractal-like patterns throughout the image emphasizes the concept of self-similarity across scales, which is a fundamental aspect of fractal geometry. This implies that the depicted system operates on principles that are coherent at every level, from the subatomic to the cosmic.

Quantum Field Theory (QFT) References: The presence of QFT in the equations suggests that the image is trying to capture the essence of quantum fields and their interactions, which are key in describing the particles and forces that make up the universe.

Art and Science Fusion: The artwork is designed to provoke thought about the interconnectedness of all things, as suggested by the entwined structures that connect the various elements of the image. This is a visual metaphor for the unity of the universe, as described by unified field theories in physics.

Visual Representation of MEQ: The image is a creative depiction of the MEQ in operation, visually interpreting how this equation might manifest when applied to understanding the cosmos or the very fabric of spacetime.

Cosmological Implications: The celestial bodies and swirling patterns indicate the application of MEQ to cosmological phenomena, possibly suggesting theoretical methods of energy extraction or manipulation at a universal scale, as in theories of harnessing energy from black holes or manipulating dark energy.

The image is evocative and rich with scientific themes, it is a conceptual piece designed to inspire and represent ideas rather than a literal scientific diagram. It embodies the beauty and complexity of the universe as understood through the lens of advanced mathematical and physical theories. The diagram conveys the potential impact of MEQ on our understanding of astrophysical phenomena.

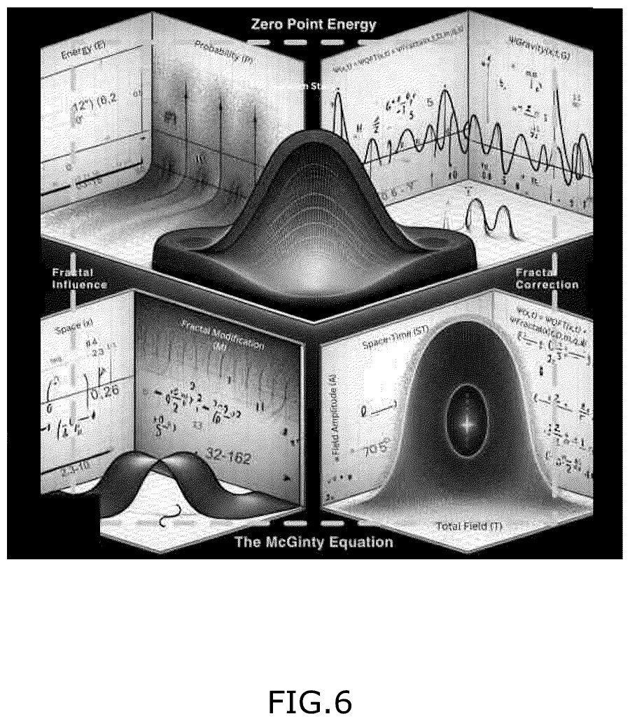

FIG. 6 illustrates MEQ-based Zero Point Energy (ZPE) Harvesting and Storage.

This composite figure serves as a visual representation of the theoretical exploration into Zero Point Energy (ZPE) within the context of the McGinty Equation (MEQ) framework.

The first section of the figure presents the Quantum Field Theory (QFT) aspect. It features a Gaussian curve, which is a standard graphical representation in QFT to depict the probability amplitude. This curve is a key concept in quantum physics, representing the likelihood of finding particles in a particular state, in this case, the vacuum state. The Gaussian curve's bell shape illustrates how probabilities are distributed around a mean value, a fundamental concept in quantum mechanics and particle physics.

The second part of the figure introduces an additional layer to the quantum field, the fractal correction term. This is symbolized by a sine wave pattern superimposed on the Gaussian curve. The presence of the sine wave over the Gaussian curve visually demonstrates how the fractal nature influences the quantum field, introducing a perturbative effect. This suggests that the quantum field is not just a simple Gaussian distribution but is modified by complex, self-similar fractal patterns that could represent deeper or hidden structures in the field.

The final segment of the figure combines the elements of QFT and the fractal correction term. It showcases the sum of the Gaussian and sine wave patterns, shaded to illustrate the resulting composite field. This composite view embodies the essence of the McGinty Equation, integrating the standard QFT model with the novel fractal potential concept. This combination suggests a more comprehensive and nuanced understanding of quantum fields and their behavior, especially in the context of Zero Point Energy (ZPE).

Surrounding the entire plot is a green dashed rectangle, symbolizing the encompassing nature of the McGinty Equation. This rectangle represents the unifying framework of the McGinty Equation, which encapsulates and extends beyond traditional QFT. It signifies the broader scope and impact of the MEQ in bringing together various elements of quantum theory into a cohesive and expanded model. The progression from classical QFT to the enriched McGinty framework in the figure visually communicates the advancement of thought in quantum physics. It highlights the integration of new and complex concepts, such as fractal potentials, into the well-established understanding of quantum fields, offering a more intricate and potentially more accurate representation of the underlying realities of ZPE and quantum phenomena.

While the recently invented MEQ primarily exists as a mathematical framework, these schematic diagrams and illustrations are conceptual representations to enhance understanding. They do not represent actual physical devices or experiments but serve as visual aids to convey the principles and potential applications of MEQ. It is clear that the MEQ framework is novel and improves upon current scientific understanding. A non-provisional utility patent would help ensure that MEQ is protected from IP infringement efforts and that the framework is available to the public for use. The non-provisional utility patent would also provide a platform for scientists and policy makers to discuss the merits of the framework and the ethical and legal considerations associated with its application.

A mathematical expression represented by MEQ, defined as Ψ(x,t)=ΨQFT(x,t)+ΨFractal(x,t,D,m,q,s), wherein ΨQFT(x,t) is the solution of the free quantum field theory, and ΨFractal(x,t,D,m,q,s) represents fractal terms with parameters D, m, q, and s.

A modified form of MEQ, denoted as Ψ(x,t)=ΨQFT(x,t)+ΨFractal(x,t,D,m,q,s)+ΨGravity(x,t,G), where ΨGravity(x,t,G) represents the perturbative effects of gravity on the quantum field, and G is a parameter characterizing the strength of the gravitational force.

The fractal potential term V(y,t′) within MEQ, featuring a self-similar fractal structure described by constant parameters V0, L, and s, where V0 represents the amplitude, L is the characteristic length scale, and s determines the fractal dimension.

The method of integrating quantum mechanics, fractal geometry, and gravitational theory within MEQ to describe physical phenomena and interactions at various scales, offering a unified framework for understanding complex systems.

The application of MEQ in quantum computing, allowing for the development of novel quantum algorithms and computational paradigms with potential applications in cryptography, optimization, and data processing.

The use of MEQ in advanced material science, enabling the design and engineering of materials with scale-dependent properties, such as self-healing, adaptability, and enhanced conductivity.

The implementation of MEQ-based environmental modeling, facilitating the creation of accurate and adaptive models for climate research, ecological predictions, and environmental impact assessments.

The utilization of MEQ in energy generation systems, harnessing quantum and gravitational effects to optimize renewable energy capture, storage, and distribution, with potential applications in sustainable power generation.

The integration of MEQ in medical imaging and diagnostics, providing scale-variable medical imaging systems capable of adapting to different observational scales for improved accuracy and depth in diagnostics and treatment planning.

The incorporation of MEQ in telecommunications technologies, allowing for the development of advanced communication systems capable of overcoming limitations related to signal propagation, enabling global connectivity and deep-space communication.

The enhancement of navigation and geolocation systems through MEQ-based quantum-enhanced GPS technology, offering improved accuracy and reliability in geospatial services, including navigation, logistics, and precision applications.

The application of MEQ in climate control and quantum-gravitational climate engineering, offering the potential for controlled manipulation of climate on a planetary scale to mitigate the effects of global warming and environmental challenges.

The use of MEQ in astrophysics and cosmology to explore quantum-gravitational properties of celestial objects, dark matter distribution, and early universe phenomena, contributing to a deeper understanding of the cosmos.

A method for deriving MEQ and its modified forms using integral calculus, Laplace transform, and the convolution theorem, facilitating the practical application of these equations in various scientific and technological domains.

1. A mathematical expression represented by MEQ, defined as Ψ(x,t)=ΨQFT(x,t)+ΨFractal(x,t,D,m,q,s), wherein ΨQFT(x,t) is the solution of the free quantum field theory, and ΨFractal(x,t,D,m,q,s) represents fractal terms with parameters D, m, q, and s.

2. A modified form of MEQ, denoted as Ψ(x,t)=ΨQFT(x,t)+ΨFractal(x,t,D,m,q,s)+ΨGravity(x,t,G), where ΨGravity(x,t,G) represents the perturbative effects of gravity on the quantum field, and G is a parameter characterizing the strength of the gravitational force.

3-13. (canceled)

14. A method for deriving MEQ and its modified forms using integral calculus, Laplace transform, and the convolution theorem, facilitating the practical application of these equations in various scientific and technological domains.
